(19) United States
(12) Patent Application Publication
(10) Pub. No.: US 2006/0122769 A1
(43) Pub. Date: Jun. 8, 2006

(54) Navigation system

(75) Inventor: Tsuyoshi Hotehama, Obu-city (JP)

Correspondence Address: POSZ LAW GROUP, PLC, 12040 SOUTH LAKES DRIVE, SUITE 101, RESTON, VA, 20191, US

(73) Assignee: DENSON CORPORATION, kariya-city (JP)

(21) Appl. No.: 11/290,424

(22) Filed: Dec. 1, 2005

(30) Foreign Application Priority Data
Dec. 2, 2004 (JP) 2004-349720

(51) Int. Cl. G01C 21/36

(52) U.S. Cl. 701/209; 701/200; 340/995.19

(57) ABSTRACT

A navigation system for a vehicle includes a display for displaying a current position of the vehicle on an electronic map, a panel for detecting a reference point inputted by a user of the navigation system relative to a content of the display, a pointing operation detection means for detecting a number of reference points and a control means for controlling the navigation system and other devices based on the number of the reference points.

### CROSS REFERENCE TO RELATED APPLICATION

This application is based on and claims the benefit of priority of Japanese Patent Application No. 2004-349720 filed on Dec. 2, 2004, the disclosure of which is incorporated herein by reference.

### FIELD OF THE INVENTION

The present invention generally relates to a navigation system that is used in a vehicle.

### BACKGROUND OF THE INVENTION

A navigation system used in a vehicle serves a driver of the vehicle for assisting safe and efficient driving operations. The navigation system uses the Global Positioning System (GPS) for detecting a current position of the vehicle, and displays the detected position on a map in a display device together with a road map and a route to a destination for navigating the driver.

In recent years, the display device of the navigation system is equipped with a touch panel as disclosed in Japanese Patent Document JP-A-2004-184168. The touch panel displays a plurality of menu buttons, and those buttons are coupled with functions such as a “expansion/reduction of scale” function, a “route display” function or the like.

However, a user of the navigation system has to recognize the function of those buttons by observing the shape and/or text displayed therein before touching those buttons. Therefore, the eye of the user of the navigation system (i.e., a driver of the vehicle) has to be directed toward the display device of the navigation system for a period of time. The eye directed away from a front space of the vehicle is problematic especially when the vehicle is traveling.

In addition, a hierarchical menu system that displays cascading menu screens demands the user to press the menu buttons for a couple of times in a series. Therefore, a frequently used function cannot be executed promptly.

### SUMMARY OF THE INVENTION

In view of the above-described and other problems, the present invention provides a navigation system for a vehicle that provides an easy and prompt access to a function without observation of menu buttons on a display device.

The present invention also provides an access to a function that is not represented by the menu button on the display device by using a shortcut functionality.

The navigation system of the present invention includes a touch panel and a control function. The touch panel is equipped with a reference point detection function for detecting a reference point inputted by a user of the navigation system and a pointing operation detection function for detecting a number of reference point inputted by the user. The touch panel is used in combination with a display device that is used for displaying an electronic map. The touch panel is used for receiving an input by the user with reference to the electronic map or other information displayed on the display device. The touch panel uses a well-known type of detection method that uses an infrared light, a resistive film or the like. The control function controls the navigation system or other devices based on the number of reference points on the touch panel inputted by the user. More practically, the control function is used for expanding/reducing a map on the display device, controlling a volume of a guidance voice, controlling temperature of air-conditioning or the like. In this manner, the user can select a desired function of the navigation system or other devices only by inputting the reference points on the touch panel without observing the text in a menu button or the like.

According to one aspect of the present invention, the touch panel used in the navigation system distinguishes the need of the user based on the inputted reference points on the panel. That is, the number of the reference points and their relative positions are sent to the control function for a decision of the need of the user. The relative positions of the reference points are, for example, defined relative to a virtual dividing line that vertically or horizontally divides a display area of the display device into two portions. The input of the reference points in an upper half of the panel may be, for example, interpreted as an instruction of map expansion, and the input of the reference points in a lower half of the panel may be interpreted as an instruction of map reduction. In this manner, the user can execute various functions by inputting reference points of a predetermined number in an area that is roughly defined in the panel.

According to yet another aspect of the present invention, the navigation system displays an expanded view of the map that is included in a rectangle defined by two reference points inputted by the user. In this manner, the user can display a desired area of the map in a magnified view by roughly inputting two diagonal points of the desired area.

According to still yet another aspect of the present invention, the navigation system includes a contact duration detection function for detecting a time of contact by the user. The control function executes a predetermined function when the time of contact is greater than a predetermined time. In this manner, an input to the panel mistakenly given by the user does not cause a trouble or a false operation of the navigation system.

According to still yet another aspect of the present invention, the functions controlled by the control function are practically defined as at least one of expansion/reduction of the displayed map, control of a guidance voice volume, control of the temperature of air-conditioning, display of the route to a user's home, and display of a telephone number search screen.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present invention;

FIGS. 2A and 2B show an illustration of usage of the navigation system in the embodiment of the present invention;

FIG. 3 shows a flowchart of a control process;

FIGS. 4A and 4B show an illustration of the navigation system in a modified embodiment;

FIG. 4C shows a table of functions correlated with a reference point;

FIG. 5 shows a flowchart of another control process; and

FIGS. 6A and 6B show an illustration of another modification of the embodiment of the present invention.

### DETAILED DESCRIPTION OF THE PREFERRED EMBODIMENTS

An embodiment of the present invention is described with reference to the drawings.

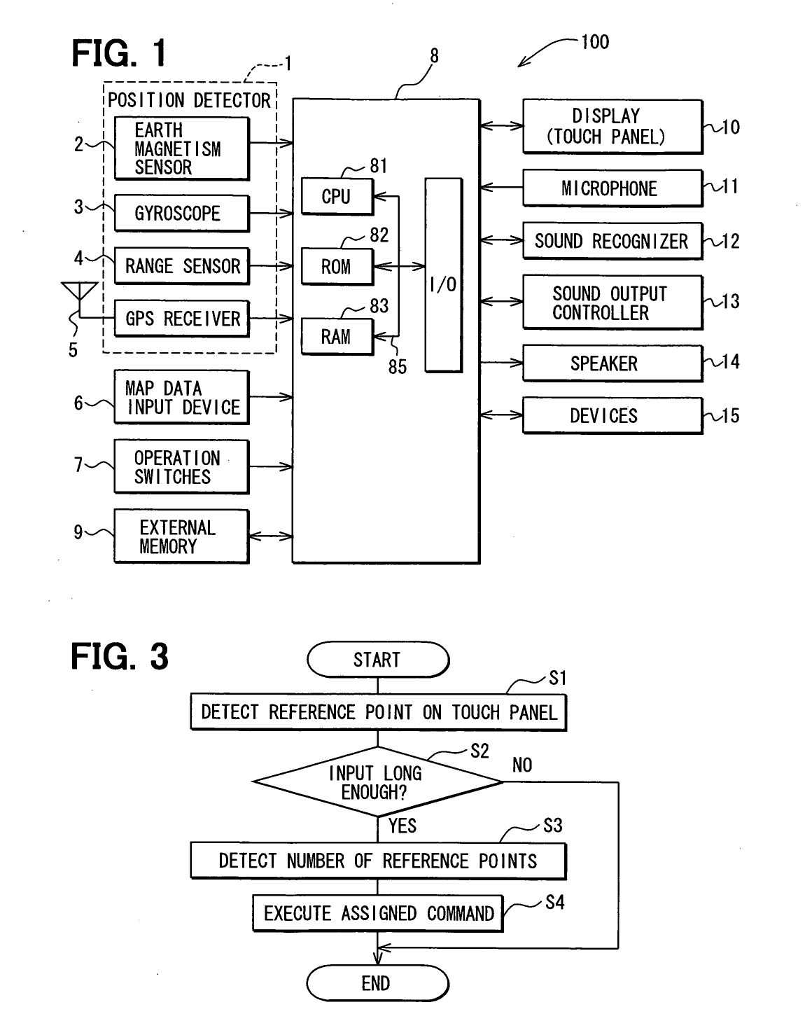

FIG. 1 shows a block diagram of a navigation system 100 for a vehicle in an embodiment of the present invention. The navigation system 100 includes a position detector 1, a map data input device 6, operation switches 7, a control circuit 8, an external memory 9, a display device (a touch panel) 10, a sound input device (a microphone) 11, a sound recognizer 12, a sound output controller 13, a sound output device (a speaker) 14, and devices 15 used for other purposes.

The navigation system 100 has a so-called route guidance function for displaying an optimum route from a current location to a destination upon receiving a location of the destination from menu buttons displayed on the touch panel 10 or operation switches 7. The optimum route is calculated, for example, by using Dijkstra method or the like.

The position detector 1 includes an earth magnetism sensor 2, a gyroscope 3, a range sensor 4, and a GPS receiver 5. These sensors and devices includes errors of different natures, thereby enabling a compensation of the error with a provision of measurement with each other. The accuracy of the sensors/devices is taken into account for a separate measurement, and other sensors such as a steering rotation sensors and/or a wheel sensor may also be used.

The map data input device 6 is used for inputting various kinds of data that is used for map matching, map display, landmark display or the like. The various kinds of data is stored in a CD-ROM, a DVD-ROM, a memory card or the like.

The touch panel 10 displays a current position of the vehicle derived from the position detector 1, map data inputted by using the map data input device 6, and additional data such as the optimum route to the destination and the like. The touch panel uses an infrared light and an infrared sensor for precisely detecting an input position indicated by a touch pen or a finger of a user as (X, Y) coordinates of well-known type. The position detection method used by the touch panel may be a resistive film method, an electrostatic capacity method or the like. The touch panel 10 detects the position of a reference point indicated by the user, coordinates of the reference point, and the number of the reference points by using the above-described method.

The operation switches 7 may be mechanical switches 7 or may be represented by menu buttons on the touch panel 10. The operation switches 7 are used for inputting various kinds of inputs. The sound recognizer 12 is also used for inputting various kinds of inputs. The sound recognizer 12 recognizes a sound collected with the microphone 11 by using a well-known sound recognition technology, and outputs a command corresponding to the result of the sound recognition.

The control circuit 8 is a well-known type of computer that includes a CPU 81, a ROM 82, a RAM 83, an input/output circuit (I/O) 84 and a bus line 85 for connecting these components. The ROM 82 stores a program that is used to control the navigation system 100 or other devices based on the detected number of reference points inputted from the touch panel 10. For example, the program may correlates the input by touching the panel using one finger with a map expansion function, using two fingers with a map reduction function, and using three fingers with a route display function of the navigation system 100. The program may executed other functions such as a guidance voice volume control function, a telephone number search screen display function, an air-conditioning temperature control function, a route display function (a registered destination guidance function), or the like. The CPU 81 executes a function that corresponds to the number of reference points inputted from the panel 10 when the user touches the touch panel 10.

The input from the touch panel may be correlated with a combination of the number of reference points (input points) and rough positions of the input points. For example, the input with one finger in an upper half of the touch panel 10 may be correlated with the map expansion function, and the input with one finger in a lower half of the touch panel may be correlated with the map reduction function. The functions with opposite functionality such as map expansion and reduction functions may be assigned to the inputs having opposite input areas for the ease of memorizing the convention.

The input to the touch panel 10 may be distinguished by the duration of the contact to the touch panel 10. The input less than a predetermined length of time may be discarded as a mistake for preventing a false operation of the navigation system 100. The length of time may be measured and determined by a circuit in the control circuit 8.

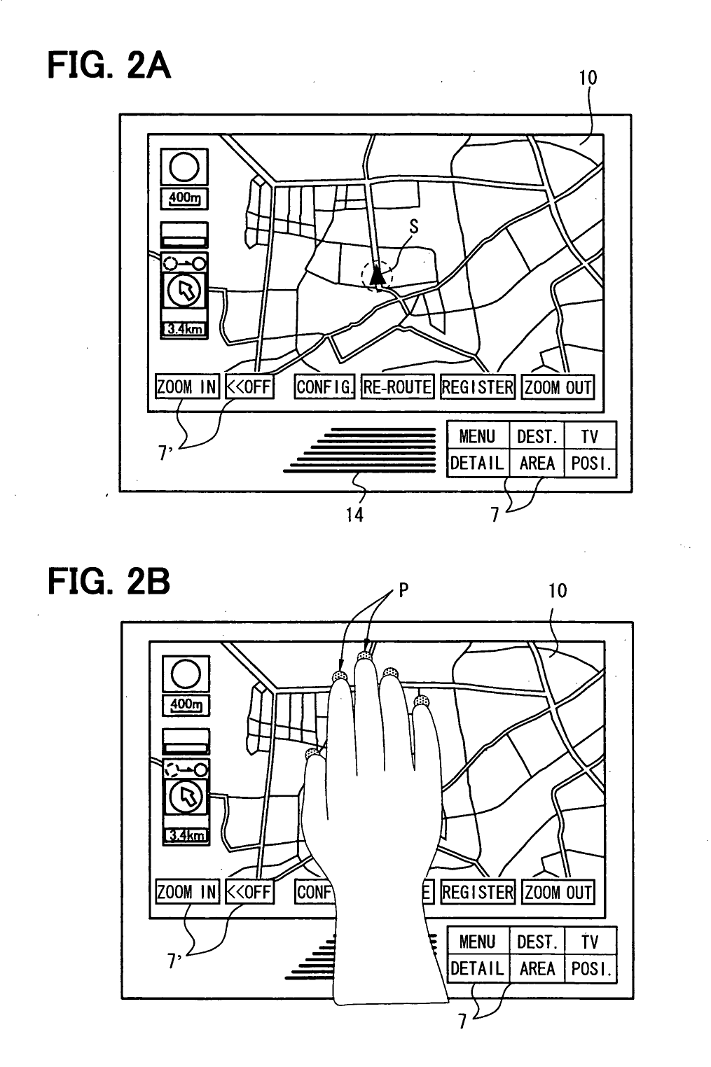

FIGS. 2A and 2B show an illustration of usage of the navigation system 100 in the embodiment of the present invention. As shown in FIG. 2A, the navigation system 100 includes the touch panel 10, the speaker 14, and the operation switches 7. The touch panel 10 displays a map and a current position S of the vehicle. Menu buttons 7′ at a bottom of the touch panel 10 are used in the same manner as the operation switches 7. The touch panel 10 detects the reference point P indicated by the user as shown in FIG. 2B when the user touches the touch panel 10. The navigation system 100 and other devices are controlled by the control circuit 8 based on the detected number of the reference points P.

FIG. 3 shows a flowchart of a control process.

In step S1, the reference point P on the touch panel 10 inputted by the user is detected.

In step S2, the duration of the input of the reference point P is measured and determined if it is greater than a predetermined value. When step S2 is YES, the control process proceeds to step S3. The control process skips steps S3 and S4 when step S2 is NO based on a determination that the user mistakenly pressed the touch panel 10.

In step S3, the number of the reference points P is detected. Then, in step S4, the CPU 81 executes a function that corresponds to the detected number of the reference points.

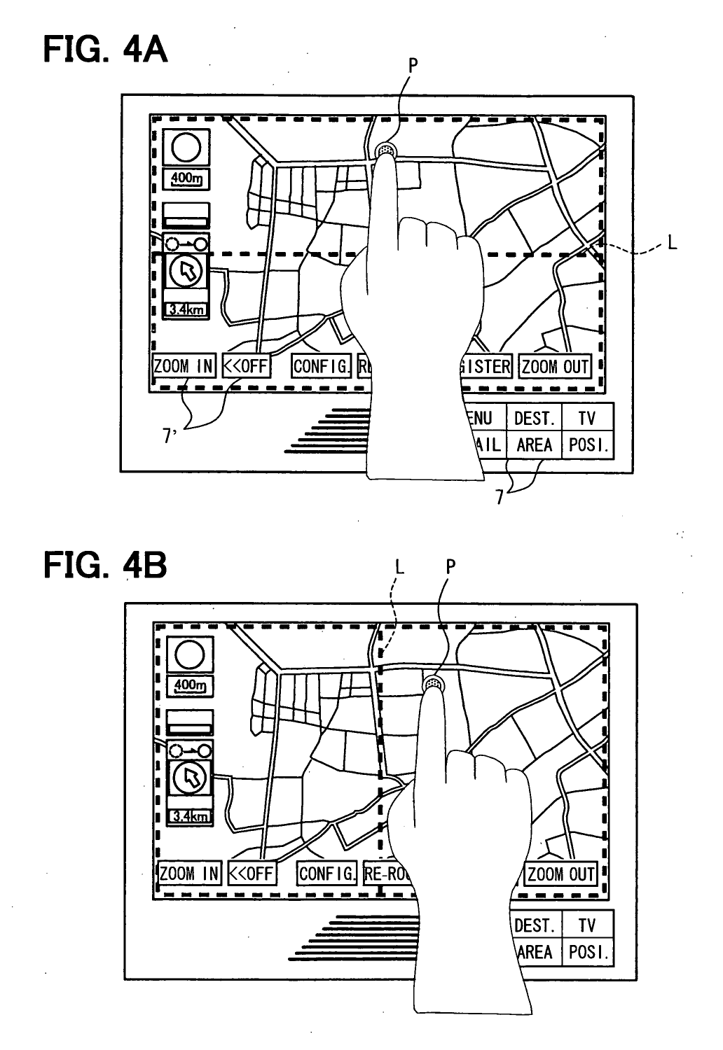

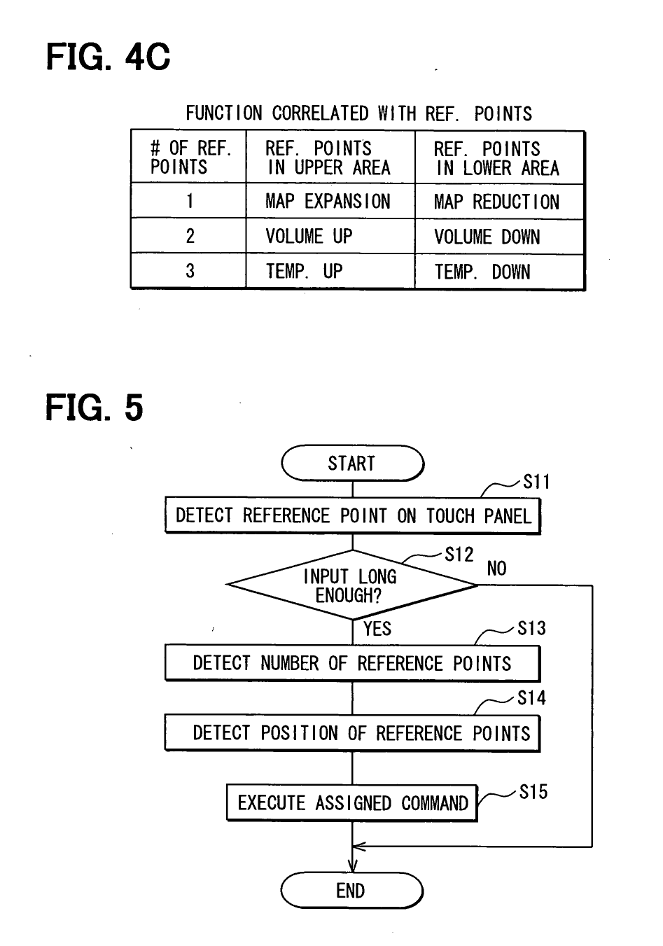

Next, a modification of the embodiment is described with reference to FIGS. 4A, 4B and 5.

FIGS. 4A and 4B show an illustration of the navigation system in a modified embodiment. In the modified embodiment, the touch panel 10 is used for detecting the reference points roughly in two areas. The touch panel is divided into two vertically adjacent areas by a virtual line L in FIG. 4A, and is divided into two horizontally adjacent areas by the line L in FIG. 4B. Positions of the reference points P inputted by the user is determined with reference to the line L. For example, the reference point P is determined in an upper area in FIG. 4A when the position of the reference point P is determined above the line L in the touch panel 10. The determined position of the reference point P combined with the number of the reference points P is correlated to the program stored in the ROM 82 for controlling the navigation system 100 or other devices. The correlation to the stored programs of the functions may be specified in a manner described in a table in FIG. 4C.

FIG. 5 shows a flowchart of another control process.

In step S11, the touch panel 10 detects the reference point P inputted thereon.

In step S12, the duration of the input of the reference point P is measured and determined if it is greater than a predetermined value. The number and position of the reference points P is detected in steps S13 and S14 when the duration of the input is greater than a predetermined value. The CPU 81 executes the program in the ROM 82 based on the combination of the number and position of the detected reference points P in step S15.

The control process in step S14 determines the position of the reference point P relative to the virtual line L. When the positions of the reference points P are detected on both sides of the line L, step S15 may be skipped because of the ambiguity of the user's input. The reference points P may be interpreted based on the number of the points on both sides of the line L. That is, for example, the input from the upper area of the touch panel 10 is prioritized when the upper area has a greater number of the reference points P.

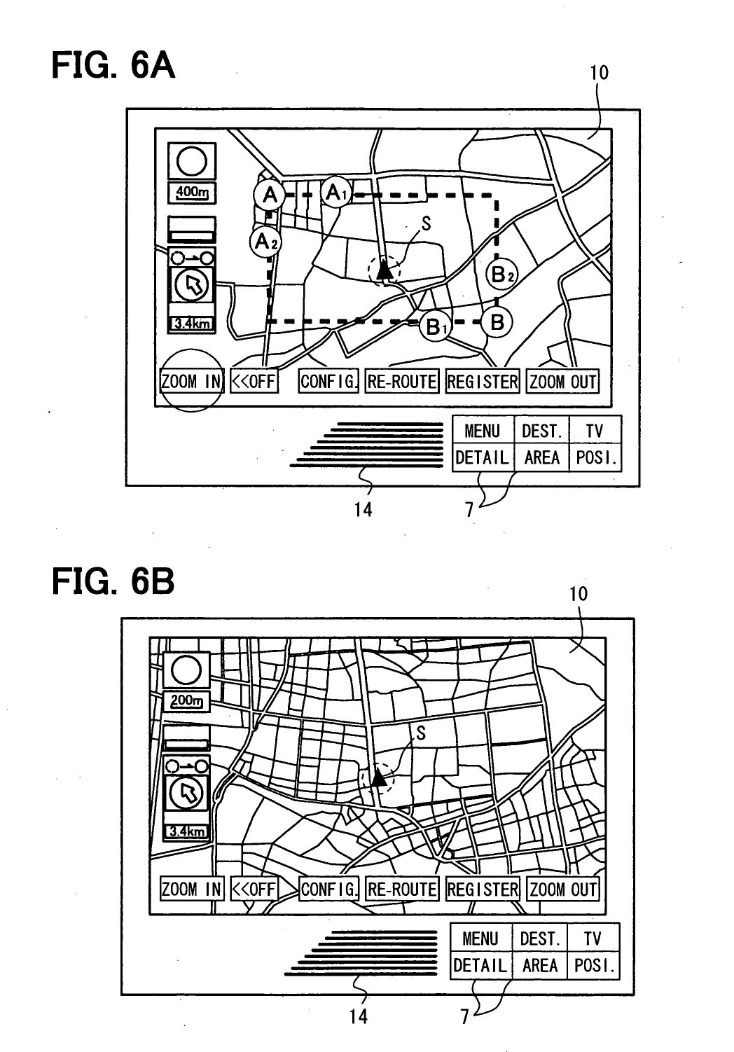

FIGS. 6A and 6B show an illustration of another modification of the embodiment of the present invention. In this modification of the embodiment, a portion of the map specified by two diagonal corners given by the user is expansively fitted in the display device (touch panel) 10. That is, a point A and a point B on the dotted rectangle in FIG. 6A specifies the two diagonal corners of the map expansively fitted in the display device 10 shown in FIG. 6B. A combination of a point A1 and a point B1, or a combination of a point A2 and a point B2 specifies the same rectangular area shown in FIG. 6B. Though the same result can be achieved by touching a “ZOOM IN” button on a lower left corner of the touch panel 10 in FIG. 6A, specifying the two diagonal corners device in the present invention is much more intuitive and prompt way of instruction for expanding the map on the display device 10.

Although the present invention has been fully described in connection with the embodiment with reference to the accompanying drawings, it is to be noted that various changes and modifications will become apparent to those skilled in the art.

For example, the menu buttons displayed in the touch panel 10 may be erased from the panel 10. That is, the menu buttons may not be required for executing a desired function because the function is accessible by touching an area of the touch panel 10. Therefore, the present invention allows the user (e.g., a driver of the vehicle) to execute the desired function simply by contacting the touch panel 10 without observing the text or the like on the panel 10, and thereby preventing the attention of the user from being distracted.

Such changes and modifications are to be understood as being within the scope of the present invention as defined by the appended claims.

What is claimed is:

1. A navigation system for a vehicle comprising:
a display for displaying a position of the vehicle on an electronic map;
a panel for detecting a reference point inputted by a user of the navigation system relative to a content of the display;
a pointing operation detection means for detecting a number of reference points inputted by the user; and
a control means for controlling at least one of the navigation system and other devices based on the number of the reference points.

2. A navigation system for a vehicle comprising:
a display for displaying a position of the vehicle on an electronic map;
a panel for detecting a reference point inputted by a user of the navigation system relative to a content of the display;
a pointing operation detection means for detecting a number of reference points and coordinates of each of the reference points inputted by the user; and
a control means for controlling at least one of the navigation system and other devices based on the number of the reference points.

3. The navigation system according to claim 2,
wherein the control means controls the navigation system for displaying an area of the electronic map defined by at least two reference points.

4. The navigation system according to claim 3 further comprising,
a contact duration detection means for detecting a duration of contact on the panel by the user,
wherein the control means controls the navigation system when the duration of contact is greater than a predetermined value.

5. The navigation system according to claim 2,
wherein the control means controls at least one of a map expansion/reduction function, a guidance volume control function, a air-conditioning temperature control function, a route display function, and a telephone number search function.
